(19) United States
(12) Patent Application Publication
(10) Pub. No.: US 2010/0045475 A1
(43) Pub. Date: Feb. 25, 2010

(54) SHAKE RESPONSIVE HANDHELD DEVICE

(75) Inventors: CHUAN-HONG WANG, Tu-Cheng (TW); HSIAO-CHUNG CHOU, Tu-Cheng (TW); LI-ZHANG HUANG, Tu-Cheng (TW); CHIA-YU CHENG, Tu-Cheng (TW); JUI-LIN KE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/464,085

(22) Filed: May 11, 2009

(30) Foreign Application Priority Data
Aug. 22, 2008 (CN) 200810304147.4

(51) Int. Cl. G08B 21/00

(52) U.S. Cl. 340/686.1

(57) ABSTRACT

A shake responsive handheld device is provided. The handheld device comprises a motion sensing unit, a storage unit, a motion determining unit, and a processing unit. The motion sensing unit is used for detecting a shaking motion imparted to the handheld device by a user. The storage unit stores a table defining a plurality of gaming results and shaking characteristics, each of which corresponds to one gaming result. The motion state determining unit determines the shaking characteristic of the shaking motion according to signals from the motion sensing unit. The processing unit outputs one of the plurality of gaming results according to the shaking characteristic determined by the motion state determining unit.

### RELATED APPLICATIONS

This application is one of the related co-pending U.S. patent applications as listed. Such cases have the same assignee as the current application and have been concurrently filed. The disclosures of the applications listed in Table 1 are incorporated by reference in their entirety.

TABLE 1

| Attorney Docket No. | Title | Inventors |
|---|---|---|
| US19429 | SHAKE RESPONSIVE | Chuan-Hong Wang |
| | HANDHELD DEVICE | Hsiao-Chung Chou |
| | | Li-Zhang Huang |
| | | Xiao-Guang Li |
| US19430 | SHAKE RESPONSIVE | Chuan-Hong Wang |
| | HANDHELD DEVICE | Hsiao-Chung Chou |
| | | Li-Zhang Huang |
| | | Chia-Yu Cheng |
| | | Cheng-Hao Chou |
| | | Jui-Lin Ke |

### BACKGROUND

1. Technical Field

The present disclosure relates to shake responsive handheld devices and, more particularly, to a shake responsive handheld device for simulating the shaking of dice.

2. Description of Related Art

Many portable computing devices, such as personal digital assistants (PDAs), cellular phones, and portable media players, enable users to play games of chance, for example, games that require a user to roll simulated dice and make moves based upon the outcome of the dice roll. One common dice game for Motorola and Nokia mobile phones is “Jacado Dice”, a game in which users place bets and press a button to toss the simulated dice.

In general, such dice games are played by rolling the dice for the user automatically or based upon a simple button press, which differs significantly from the experience of physically rolling dice. In the real world, there is a causal relationship between physically tossing dice and observing the outcome that has made dice games so popular over the centuries. Therefore, there is a need to provide a handheld device that can be shaken to simulate dice rolling in the real world.

### BRIEF DESCRIPTION OF THE DRAWINGS

FIG. 1 is a block diagram of a handheld device in accordance with an exemplary embodiment of the present disclosure.

FIG. 2 shows a relationship table in accordance with an exemplary embodiment that is stored in a storage unit of the handheld device of FIG. 1.

FIG. 3 is an assembled, cross-sectional view of the vibration switch shown in FIG. 1 in accordance with an exemplary embodiment of the present disclosure.

FIG. 4 is an assembled, cross-sectional view of the vibration switch of FIG. 1, taken from the line II-II in FIG. 3.

FIG. 5 is an assembled, cross-sectional view of the vibration switch of FIG. 1 in accordance with another exemplary embodiment of the present disclosure.

### DETAILED DESCRIPTION

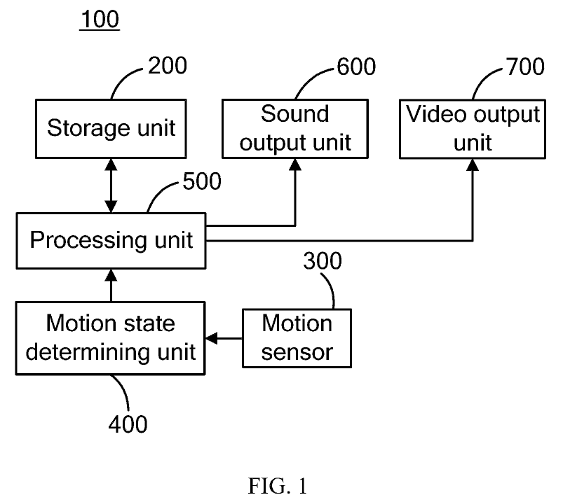

FIG. 1 shows a block diagram of a handheld device 100 in accordance with an exemplary embodiment of the present disclosures. The handheld device 100 includes a storage unit 200, a motion sensor 300, a motion state determining unit 400, a processing unit 500, a sound output unit 600, and a video output unit 700.

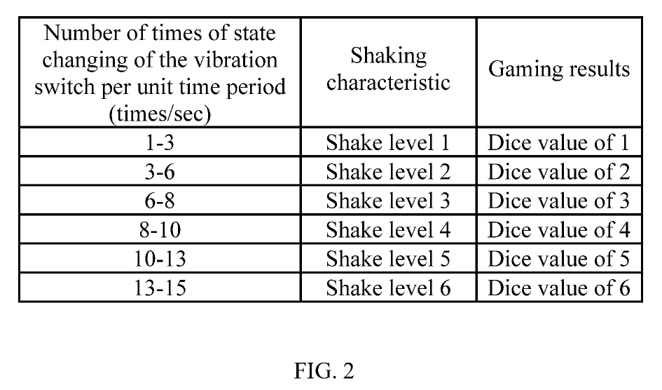

The storage unit 200 can be any appropriate storage medium, such as a read-only memory or a random-access memory, and stores a relationship table. The table defines a relationship of a plurality of gaming results and shaking characteristics of a shaking motion imparted to the handheld device 100. In an exemplary embodiment, the gaming results are values of one or more dice. The shaking characteristics are parameters used to characterize the shaking motion of the handheld device. In an exemplary embodiment, the shaking characteristics are shaking levels, which indicate how strongly the handheld device 100 is shaken. As shown in FIG. 2, each shaking characteristic corresponds to one gaming result.

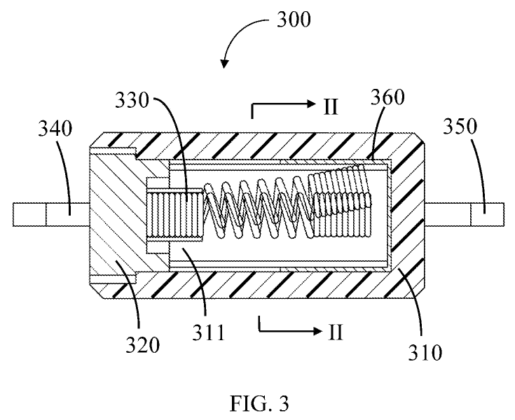

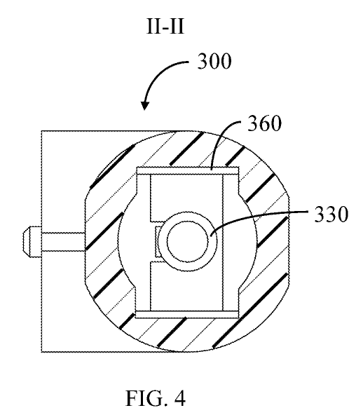

Referring to FIGS. 3 and 4, in an exemplary embodiment, the motion sensor 300 is a vibration switch and comprises a housing 310, a side cap 320, a coil spring 330, a first contact terminal 340, a second contact terminal 350, and a metal sheet 360.

A chamber 311 is formed in the housing 310. The side cap 320 is attached to the opening end of the housing 310 to cover the chamber 311. The coil spring 330 is received in the chamber 311 in a cantilevered way, that is, one end the coil spring 330 is attached to the side cap 320 and is electrically coupled to the first contact terminal 340, while the other end of the coil spring 330 is floated.

The metal sheet 360 is positioned on the inner surface of the chamber 311 and electrically coupled to the second contact terminal 350. Specifically, the metal sheet 360 is configured in such a way that the coil spring 330 is capable of deflecting and contacting the metal sheet 360 when being shaken in a predetermined direction.

When the housing 310 is shaken in a direction approximately perpendicular to the metal sheet 360, the coil spring 330 deflects and the floating end of the coil spring is capable of coming into contact with the metal sheet 360, which makes the vibration switch 300 change from an electrically open state to an electrically closed state. Thus, during the shaking of the housing 310, the vibration switch 300 keeps changing its state between the electrically closed state and the electrically open state. After the shaking of the housing 310 has ceased, the coil spring 330 recovers its original shape and position and the vibration switch 300 returns to the electrically open state.

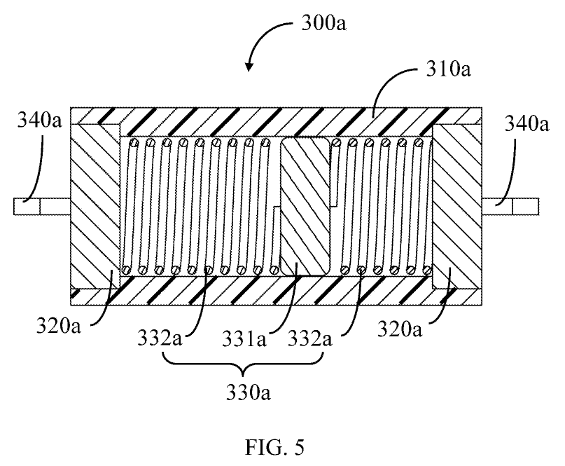

Referring to FIG. 5, in another embodiment, the vibration switch 300a includes a housing 310a, two side caps 320a, a movable member 330a, and two contact terminals 340a. A chamber 311a is formed in the housing 310a. The two side caps 320a are attached to two ends of the housing 310a respectively to cover the chamber 311a, and are electrically coupled to the two contact terminals 340a, respectively.

The movable member 330a comprises an inertial weight 331a and two coil springs 332a. The coil springs 332a are attached to two ends of the inertial weight 331a respectively and are in contact with the two side caps 320a. When the housing 310a is shaken in a longitudinal direction, the inertial weight 331a moves in the chamber 311a and one of the two coil springs 332a is capable of being out of contact with one of the two side caps 320a, making the vibration switch 300a change from an electrically open state to an electrically closed state.

During the shaking of the handheld device 100, the motion state determining unit 400 continues receiving signals from the vibration switch 300, such that the duration time of the shaking of the handheld device 100 and the number of times of state changing of the vibration switch 300 in the duration time can be obtained. As shown in FIG. 2, in an exemplary embodiment, the relationship between the shake levels of the shaking motion of the handheld device 100 and the number of times of state changing of the vibration switch 300 is defined in the table.

The processing unit 500 outputs one of the gaming results corresponding to the shake level determined by the motion state determining unit 400 according to the table. In an exemplary embodiment, the gaming results are outputted by voice from the sound output unit 600.

Therefore, every time a user shakes the handheld device 100, they may obtain different dice values due to different shake levels or shake strengths, which is similar to rolling dice in the real world. Further, a user may have the chance of obtaining the same dice values every time by shaking the handheld device with approximately the same shake strength, which provides the user with a feeling that they can control the gaming results of rolling dice.

Although the motion sensor 300 in the embodiment described above is a vibration switch, the motion sensor 300 may be an acceleration sensor. In case of an acceleration sensor, acceleration value of the shaking of the handheld device 100 can be obtained and the shake level of the shaking of the handheld device 100 is determined based on the acceleration value. The acceleration value, as used herein, is a mean value of the acceleration of the shaking of the handheld device 100.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A shake responsive handheld device comprising:
a motion sensing unit capable of detecting a shaking motion imparted to the handheld device by a user;
a storage unit storing a table defining a relationship between a plurality of gaming results and shaking characteristics of the shaking motion;
a motion state determining unit capable of determining the shaking characteristic of the shaking motion according to signals from the motion sensing unit; and
a processing unit outputting one of the plurality of gaming results corresponding to the shaking characteristic determined by the motion state determining unit according to the table.

2. The shake responsive handheld device according to claim 1, wherein the motion sensing unit is an acceleration sensor.

3. The shake responsive handheld device according to claim 1, wherein the motion sensing unit is a vibration switch.

4. The shake responsive handheld device according to claim 3, wherein the vibration switch comprises a coil spring, a first contact terminal, and a second contact terminal, the coil spring is electrically coupled to the first contact terminal and is capable of deflecting and contacting the second contact terminal during the shaking of the handheld device.

5. The shake responsive handheld device according to claim 3, wherein the coil spring deflects when the housing is shaken in a predetermined direction.

6. The shake responsive handheld device according to claim 3, wherein the vibration switch comprises a chamber, a movable member with two spring ends, and two contact terminals, the moveable member is received in the chamber, the two spring ends contact the first contact terminal and the second contact terminal respectively, at least one of the spring ends is capable of disengaging one of the two contact terminals during the shaking of the handheld device.

7. The shake responsive handheld device according to claim 6, wherein the movable member comprises an inertial weight and two coil springs, the two coil springs are attached to two ends of the inertial weight respectively.

8. The shake responsive handheld device according to claim 1, wherein the shaking characteristics is represented by shaking strength of the shaking motion.

9. The shake responsive handheld device according to claim 1, wherein the gaming results are dice values.
